(19) United States
(12) Patent Application Publication
(10) Pub. No.: US 2020/0334336 A1
(43) Pub. Date: Oct. 22, 2020

(54) GENERATION OF SCRIPTED NARRATIVES

(71) Applicant: Scriptbook NV, Antwerpen (BE)

(72) Inventor: Nadira AZERMAI, Lokeren (BE)

(21) Appl. No.: 16/389,198

(22) Filed: Apr. 19, 2019

(51) Int. Cl. G06F 17/28; G06F 17/27; G06F 17/24

(52) U.S. Cl. CPC G06F 17/2881; G06F 17/241; G06F 17/277

(57) ABSTRACT

Example embodiments describe a computer-implemented method for generating a scripted narrative by a machine learning model comprising: i) predicting the scripted narrative as a sequence of annotated sentences comprising one or more tokens and a paragraph type; and wherein a token is selectable from a token group comprising at least a word token indicative for a word in the scripted narrative and a reference token indicative for a term that refers to a character; and wherein, when a token is a reference token, it is further annotated with an identification of the referred character; ii) iteratively predicting a next annotated sentence based on a sequence of preceding annotated sentences.

### TECHNICAL FIELD

The present invention relates to the automated generation of scripted narratives.

### BACKGROUND

The automated generation of scripted narratives is driven by the film and television industry due to the ever-growing demand for new content. Automation of the scripting process would further optimize production time and make the overall production more economical.

The most promising advancements are being made in the field of natural language generation, NLG, and, more particular, by the use of machine learning models. State of the art machine learning models rely on the use of transformer or long short-term memory, LSTM, neural network models. These models allow learning representations at increasing levels of abstraction, making a manual division into different subtasks unnecessary.

NLG has already proven to be of great use in different applications such as for example in chatbots for replying to human queries, for machine-translation, for converting structured input data in paragraphs of text that describe the text, for captioning of video and for describing and classifying images.

However, the generation of a scripted narrative, i.e. narrative story generation, is a much more complex application. A scripted narrative is a textual story with a start and end with more stringent requirements than merely generating legible text based on input data. Besides producing grammatically correct sentences, there is a need for semantic coherence throughout a long body of generated text, the text must be produced in a strict format with different kinds of paragraphs and their specific interrelation, a narrative has characters which cannot appear randomly throughout the text, the characters must conduct conversations, the setting of the script must also be coherent etc.

In “Neural Text Generation in Stories using Entity Representations as Context” by Clark E. ea. in Proceedings of the 2018 Conference of the North American Chapter of the Association for Computational Linguistics: Human Language Technologies, Volume 1, pp. 2250-2260, a language model based on neural networks is proposed. More specifically, this language model explicitly models entities, e.g. characters, and dynamically updates these models when an entity appears explicitly in the text. This technique is proposed for generic NLG tasks as well as for short pieces of narrative text.

Other publications disclose a more modular approach wherein higher-level story representations are generated by a first module and then a natural language scripted narrative may be further generated, e.g., by a natural language generation machine learning module. Such solutions are for example proposed in: i) McIntyre, N., & Lapata, M. (2009, August), “Learning to tell tales: A data-driven approach to story generation.”, Proceedings of the Joint Conference of the 47th Annual Meeting of the ACL and the 4th International Joint Conference on Natural Language Processing of the AFNLP, Volume 1-Volume 1 (pp. 217-225), Association for Computational Linguistics; ii) Riedl, M. O., & Young, R. M. (2003, November), “Character-focused narrative generation for execution in virtual worlds”, International Conference on Virtual Storytelling (pp. 47-56). Springer, Berlin, Heidelberg; and iii) Fan, A., Lewis, M., & Dauphin, Y. (2018), “Hierarchical Neural Story Generation”, arXiv preprint arXiv: 1805.04833.

However, all of the above technologies still pose problems with generating a long and coherent narrative, especially for the characters. Due to this, there is no solution available yet that can be used in a real-life industrial television or film production environment.

### SUMMARY

It is an object of the present disclosure to overcome the above-mentioned shortcomings and to provide in a machine learning model for generating scripted narratives that results in a coherent text.

This object is achieved, according to a first example aspect of the present disclosure, by a computer-implemented method for generating a scripted narrative by a machine learning model comprising:
predicting the scripted narrative as a sequence of annotated sentences;
and wherein an annotated sentence comprises one or more tokens and a paragraph type; and wherein a token is selectable from a token group comprising at least a word token indicative for a word in the scripted narrative and a reference token indicative for a term that refers to a character; and wherein, when a token is a reference token, it is further annotated with an identification of the referred character;

and wherein the predicting further comprises:
iteratively predicting a next annotated sentence based on a sequence of preceding annotated sentences;
and wherein the predicting the next annotated sentence comprises:
predicting the paragraph type of the next annotated sentence;
iteratively predicting a next token based on the sequence of preceding annotated sentences and from previously predicted tokens.

The machine learning model thus represents a scripted narrative internally as a sequence of annotated sentences rather than a mere sequence of words. Also, the generation process itself is based on this internal per-sentence representation. This way, the narrative is encoded at a sentence level rather than at a token level. This has the advantage that the training process of the machine learning model is much easier, i.e. overarching concepts that span over several sentences are much easier to learn. Results have shown that long-term structures such as sequences of short action scenes that jump back and forth between two locations are generated. This is further enhanced by the differentiation between character references and the actual identity of the character. By this decoupling, a per-character modelling is achieved within the machine learning model. In other words, the characters are explicitly modelled as dynamic entities ensuring that the characters have a discernible state that can change over time. When measuring the accuracy of the predictions for character identification, a great improvement could be seen when compared with machine learning models that do not include such character encodings. As a consequence, the generated text comprises more plausible character references, e.g. a conversation between two characters will not contain a random introduction of another character that was not mentioned before. Furthermore, long-term consistency is further achieved by the separate per-sentence annotation of the paragraph type, rather than just treating it as a mere part of the generated text. This further encodes the long-term structure of the narrative into the machine learning model. Furthermore, also the prediction accuracy of a next token is improved considerably by the explicit character encoding resulting on its turn in a better quality text.

According to an example embodiment, the method further comprises:
encoding, by a sentence sequence model, the paragraph type and tokens of annotated sentences into respective per-sentence encodings;
encoding, by the sentence sequence model, character information of the annotated sentences into respective per-character-per-sentence encodings.

A sequence model is to be understood as a model that converts a vector sequence of arbitrary length into a single vector with a fixed-size, the encoding. In other words, the machine learning model is configured to encode an annotated sentence by the sentence sequence model into an encoding for the sentence itself, the per-sentence encodings, and into an encoding for the different characters referred to by the sentence, the per-character-per-sentence encodings. As the encoding is performed by a machine-learning model, the internal representation by the different encoders may be obtained by training the encoders simultaneously with the other parts of the machine-learning model by a set of scripted narratives.

According to an example embodiment, the method further comprises:
encoding, by a narrative encoder, from the per-sentence encodings and from the per-character encodings, a single narrative encoding.

In other words, a further encoding is performed from the generated sequences of the per-sentence encodings and per-character encodings. This further results in an encoding at the level of the narrative itself, thereby introducing an internal representation of the narrative itself. As the generation of the scripted narrative progresses, the single narrative encoding will be constantly updated based on the previously generated per-sentence encodings.

The encoding by the narrative encoder into the single narrative encoding may for example be performed by:
encoding, by a global encoder model, the per-sentence encodings into a first portion of the single narrative encoding; and
encoding, by global per-character encoder models, the per-character-per-sentence encodings into a second portion of the single narrative encoding.

In other words, the global encoder model provides an internal representation of the narrative while the global per-character encoder models provide a representation of the characters themselves throughout the narrative.

Optionally, the encoding by the global encoder model, is further performed according to a static biasing narrative encoding. In other words, the global encoder model may be biased or steered according to a predetermined narrative encoding. Such static encoding may for example be obtained from other scripted narratives with which the generated narrative should show a resemblance. Such narrative dependent bias vector is an easy and reliable way to control further properties of the text and further ensures that the style of the script remains consistent throughout its entire length.

The method may then further comprise:
determining the static biasing narrative encoding from a bias scripted narrative; and
providing the static biasing narrative encoding to the machine learning model.

Similarly, the encoding by the global per-character encoder models is further performed according to respective static biasing character encodings. This allows biasing or steering the global encoder model towards a predetermined character encoding. Such static character encoding may for example be obtained from characters of other scripted narratives with which the generated characters should show a resemblance.

The method may then further comprise:
determining, the static biasing character encoding from a bias scripted narrative; and
providing the static biasing character encoding to the machine learning model.

According to an example embodiment, is the machine learning model is trained by a set of scripted narratives.

According to a further embodiment, the method further comprises:
providing a first set of sentences as input to the machine learning model;
generating a subsequent set of sentences by the machine learning model.

This allows initializing the generation of a script, for example based on a first part of another script or by a first part that is provided by a user. Alternatively, all the sentences may be generated by the machine learning model.

An annotated sentence may further comprise a sentence character identification identifying the character speaking the sentence when applicable. This way the internal per-character representation of the machine learning model is further enhanced. Similarly, when predicting a next annotated sentence, this speaking character is predicted.

According to a second example aspect, the disclosure relates to a machine learning model comprising a decoder configured to predict a scripted narrative as a sequence of annotated sentences; and wherein an annotated sentence comprises one or more tokens and a paragraph type; and wherein a token is selectable from a token group comprising at least a word token indicative for a word in the scripted narrative and a reference token indicative for a term that refers to a character; and wherein, when a token is a reference token, it is further annotated with an identification of the referred character; and wherein the predicting further comprises:
iteratively predicting a next annotated sentence based on a sequence of preceding annotated sentences;
   and wherein the predicting the next annotated sentence comprises:
predicting the paragraph type of the next annotated sentence;
iteratively predicting a next token based on the sequence of preceding annotated sentences and from previously predicted tokens.

According to a third example aspect, the present disclosure relates to a controller comprising at least one processor and at least one memory including computer program code, the at least one memory and computer program code configured to, with the at least one processor, cause the controller to perform the method according to the first example aspect.

According to a fourth example aspect, the present disclosure relates to a computer program product comprising computer-executable instructions for performing the steps according to the first example aspect when the program is run on a computer.

According to a fifth example aspect, the present disclosure relates to a computer readable storage medium comprising computer-executable instructions for performing the steps according to the first example aspect when the program is run on a computer.

### BRIEF DESCRIPTION OF THE DRAWINGS

Some example embodiments will now be described with reference to the accompanying drawings.

FIG. 1 shows an annotated sentence according to an example embodiment;

FIG. 2 shows a representation of an example script by a sequence of annotated sentences;

FIG. 3 shows a machine learning model for generating scripted narrative according to an example embodiment;

FIG. 4 shows a sentence encoder of a machine learning model for encoding an annotated sentence into a sentence encoding and one or more character encodings according to an example embodiment;

FIG. 5 shows a narrative encoder of a machine learning model for encoding a sequence of annotated sentences and a sequence of one or more character encodings into a narrative encoding according to an example embodiment;

FIG. 6 shows a decoder of a machine learning model for predicting a next annotated sentence from a narrative encoding according to an example embodiment;

FIG. 7 shows a scripted language generator comprising a machine learning model for generating a scripted narrative according to an example embodiment; and

FIG. 8 shows an example embodiment of a suitable computing system for performing various steps according to example embodiments.

### DETAILED DESCRIPTION OF EMBODIMENT(S)

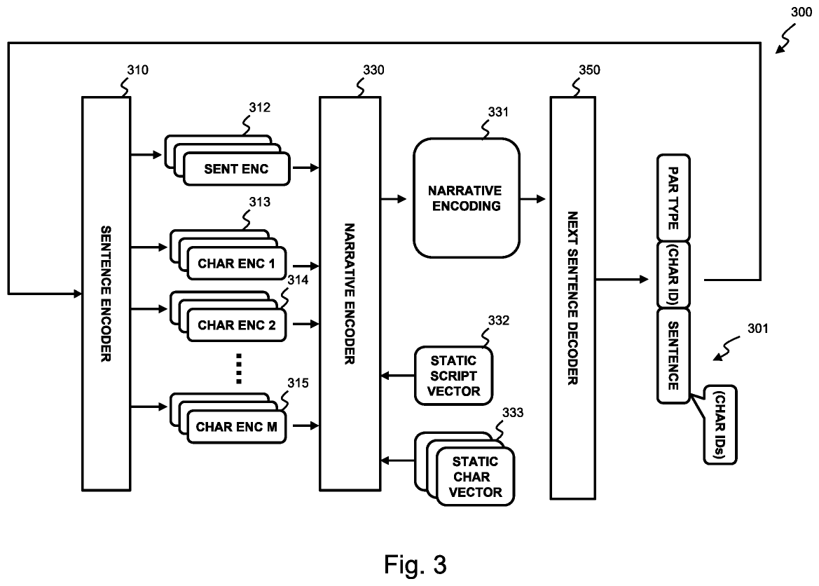

The present disclosure relates, among others, to a machine learning model for the automated generation of scripted narratives. A scripted narrative or narrative script is used to embody the narrative. Next to the narrative itself, a scripted narrative comprises further elements about the narrative, e.g. scene descriptions, character directives, structural elements such as indentations, font elements and headings to indicate the structure of the narrative rather than the story. A narrative resulting from a scripted narrative may for example relate to a screenplay, a TV series or program, a theatre play, a commercial or videogames. FIG. 3 illustrates such a machine learning model 300 according to an example embodiment. A scripted narrative is represented and thus defined within the machine learning model 300 as a sequence of annotated sentences 301. The machine learning model 300 thus takes such sequences of annotated sentences 301 as input for the purpose of training the machine learning model or generates such sequences of annotated sentences 301 when using the machine learning model for the generation of a scripted narrative. When applied in the film or television industry, the automation of the scripting process by the machine learning model 300 optimizes production time and makes the overall production more economical. Moreover, such automated storytelling helps in overcoming the so called “war on content” that has been happening in the filmed entertainment business. The demand for original scripted storytelling is high. Entertainment companies continue their bidding wars in order to own the rights to original screenplays

FIG. 1 illustrates the different components that such an annotated sentence 100 may comprise. An annotated sentence 100 comprises a paragraph type field 101 indicative for a type of paragraph to which the annotated sentence 100 belongs. Preferably, the value of the paragraph type field 101 is selectable from a list comprising at least the following values: i) a scene header indicating that the sentence describes the title of a scene in the scripted narrative, ii) an action indicating the sentence describes an action performed within the scripted narrative, iii) a dialogue indicating that the sentence is part of a dialogue conducted between characters of the scripted narrative, and iv) a parenthetical indicating that the sentence relates to a short parenthesised phrase inserting within a dialogue describing the way the dialogue should be conducted. When the paragraph type is a dialogue or a parenthetical, the annotated sentence 100 further comprises a character identification field 111 identifying the speaking character of the sentence, e.g. by having the name of the character as a value of the field 111.

Annotated sentence 100 further comprises one or more tokens 121-124. Different types of tokens may be defined. A first type of token is a token that corresponds to a word within the language corpus of the targeted scripted narrative. A second type of token is punctuation such as a comma. A third type of token is the last token 124 of the annotated sentence that identifies the end of the annotated sentence. A fourth token is a dummy token that precedes the first token 121 of the annotated sentence 100. This token may be used for initiating the prediction of a next sentence as will be described later. A fifth type of token is a character reference token 122. A reference token replaces words in the script that refer to a character. The value of the reference token 122 then indicates the kind of reference, e.g. a direct reference, a personal pronoun etc. A character reference token 122 is further associated with a character identification 125, i.e. a field identifying the character to the which the token 122 refers, e.g., by putting the name of the character as a value in the field 125.

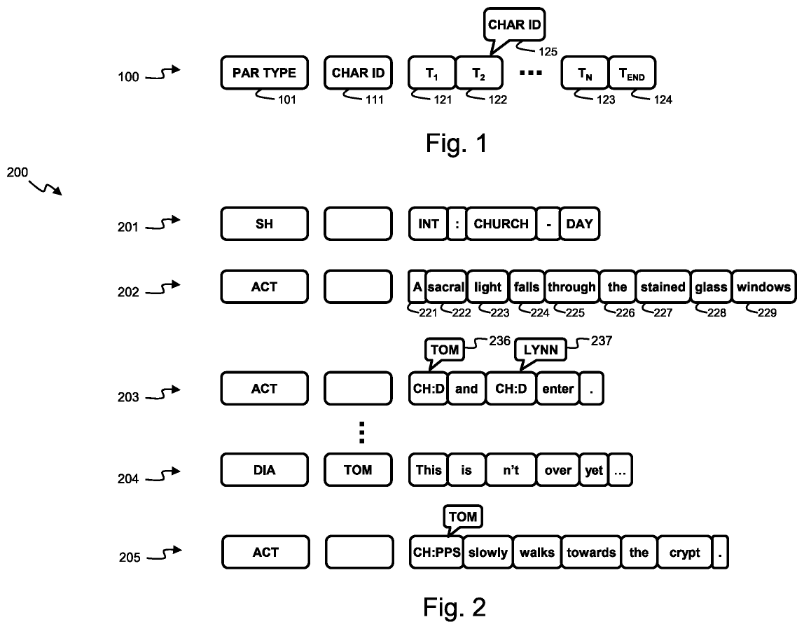

FIG. 2 shows an example 200 comprising annotated sentences 201 to 205 which are derivable from the following portion of a scripted narrative:
INT: CHURCH-DAY
A sacral light falls through the stained glass windows. Tom and Lynn enter.
   LYNN
I can't believe we are actually here!
   TOM
Don't assume anything.
This isn't over yet . . . .
He slowly walks towards the crypt.

Annotated sentence 201 describes the scene header (SH). Annotated sentence 202 describes an action (ACT) wherein each of the words is represented by respective tokens 221 to 229. In sentence 203, the words ‘Tom’ and ‘Lynn’ are replaced by reference tokens and the names are added to the identification fields 236 and 237. Sentence 204 relates to a dialogue and, therefore, the character identification field 111 contains the value ‘Tom’ because ‘Tom’ is the speaking character. When the tokens are derived from the English language, the amount of possible token values may be around 65000. The amount of token values may also be lower or higher thereby trading of the amount of processing requirements of the machine learning model against the richness of the generated language.

Machine learning model 300 uses the structure of the annotated sentence 100 to generate a scripted narrative. The model 300 comprises a so-called sentence encoder 310 that is trained to encode an annotated sentence 301 into a sentence encoding 312 and one or more character encodings 313-315, i.e. one character encoding per character. The sequence of sentence encodings 312 and the one or more sequences of character encodings 313-315 are then fed to narrative encoder 330 that is trained to encode the different sequences 312-315 into a single narrative encoding 331. Narrative encoder 330 may further be trained to take static script vectors 332 and/or static character vectors 333 as input. These so-called bias vectors 332, 333 may then be used to bias or steer the narrative encoder towards a certain direction in narrative according to the script vector or in characters according to the character vector.

The narrative encoding is then fed into a trained sentence decoder 350 that is trained to predict and, thus, generate a next sentence 301 based on the narrative encoding 331. This next sentence 301 is then fed back into the sentence encoder in order to update the narrative encoding 331 and to predict therefrom, again, a next sentence.

Scripted narratives may be converted into sequences of annotated sentences for training the machine learning model 300. This may be done by resolving the coreferences within the scripted narrative, i.e. by resolving to whom a textual reference such as a pronoun refers. Vice verso, the annotated sentences may be converted into a scripted narrative when generating the scripted narrative by the machine learning model 300.

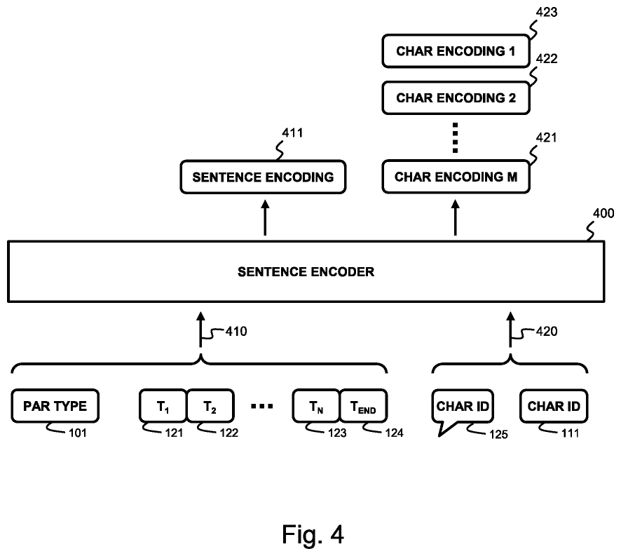

FIG. 4 illustrates an example embodiment 400 of the sentence encoder 310. Sentence encoder 400 is a sequence model that is trained to convert an annotated sentence 100 into fixed sized vector representations, i.e. into the sentence encoding 411 and character encodings 421-423. For the encoder, appropriate sequence models may be used such as for example recurrent neural networks (RNNs), Long Short Term Memory networks (LSTMs), Gated Recurrent Unit networks (GRUs), Transformer networks, and the like. As input of the sentence encoder 400, the sentence tokens 121-124, the character identifications 125 of the reference tokens 122, the paragraph type 101 and, if applicable, the character identification 111 of the speaking character is provided to the sentence encoder within the machine learning model. In other words, all constituents of a previously generated sentence 301 may serve as input for the sentence encoder. As output, the sentence encoder provides a sentence encoding which is a fixed size representation of the sentence itself, i.e., a characterization of the narrative within the sentence. Similarly, the sentence encoder provides a character encoding 421-423 for each of the characters that are referred to within the sentence, i.e. for each of the characters identified within the character identification fields 111, 125. As a result, the character encodings are a direct representation of the characters at the sentence level.

In other words, the sentence encoding 411 thus depends on the paragraph type and the tokens 410 but not on the precise identities of the speaking character or the referred characters 420. The character encodings 421-423 on the other hand are dependent on the speaking character 111 and/or character references 125.

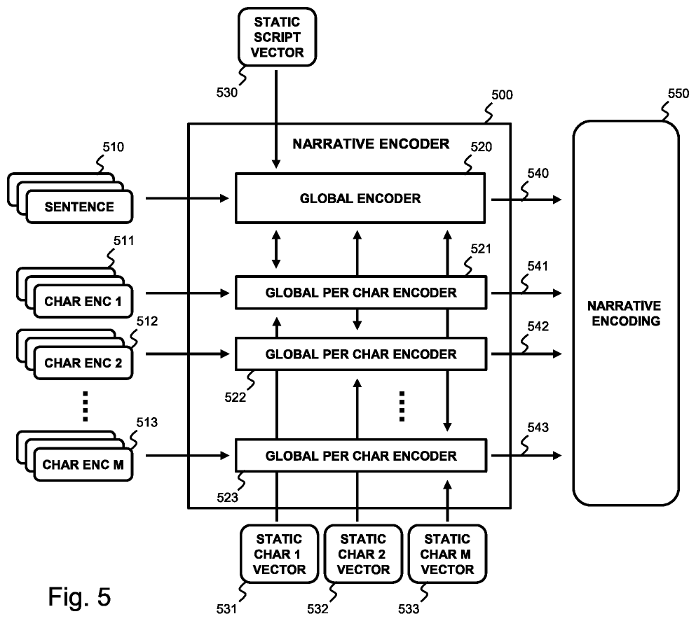

FIG. 5 illustrates an example embodiment 500 of the narrative encoder 330 within the machine learning model 300. In a first implementation, the narrative encoder model comprises a global encoder 520 that interacts with one or more global per character encoder models 521. These models are trained together to derive a single narrative encoding 550 from a current sequence of sentence encodings 510 and from one of more sequences 511-513 of character encodings. As the narrative encoder uses all previous sentence and character encoding, the generated narrative encoding 550 comprises a representation that depends on the complete history of the preceding sentences. This history will further depend on the history of the characters and on the history of the narrative itself. The narrative encoding may further be implemented as a single vector or a set of vectors comprising contributions 540, 541, 542, 543 from each of the respective encoders 521-523. The global encoder 520 and respective global per character encoders 521-523 may further also provide additional input to each other. For the different encoders 521-523, appropriate sequence models may be used such as for example recurrent neural networks (RNNs), Long Short Term Memory networks (LSTMs), Gated Recurrent Unit networks (GRUs), Transformer networks, and the like.

The global encoder may further be trained to be biased or steered from one or more static script vectors 530, i.e. from vector representations determined from other scripted narratives. By such a script vector 530, the global encoder is biased to encode a narrative encoding that shows similarities with the narrative that is represented by the static script vector 530. This way, different narrative factors such as genre or style may be imposed on the generated scripted narrative. The static script vectors 530 may be based on the content of an existing full script. Such static script vectors 530 may for example be determined from user data using matrix factorization and collaborative filtering. A technique for determining such a static script vector is for example disclosed in EP3340069A1.

Similarly, the global per-character encoders 521-523 may further be trained to be biased or steered from one or more static character vectors 531-533, i.e. from character encodings from other scripted narratives. By such a static character vector, the global per-character encoder may be biased or steered to encode a narrative encoding that shows similarities with the character represented by the static character vector. In other words, the static vectors 531-533 provide a character embedding representing a number of traits of the characters that don't change over time such as for example gender, age, profession, the distinction between main character, supporting characters or extras. Persistent qualities of characters may be encoded in such static character vectors 531-533. Furthermore, such vectors may be obtained from other scripted narratives, either scripts used for training the machine learning model 300 or any other scripted narrative.

The global encoder may further be trained to use other types of biasing encodings as input. One example is a positional encoding that is an internal representation of the relative or absolute position within the script with respect to the end of the script. Such positional encoding allows steering the generation of the scripted narrative towards a certain length or duration. A second example is a so-called biasing synopsis encoding that is a representation of a short textual summary of a storyline or a set of relevant keywords. This way, a user interacting with the machine-learning model may steer the generation process based on a short synopsis rather than complete scripted narratives as is the case with the above static script vectors. In case of a synopsis comprising a few sentences, the biasing synopsis encoding may be obtained by an encoder similar to the sentence encoder 310.

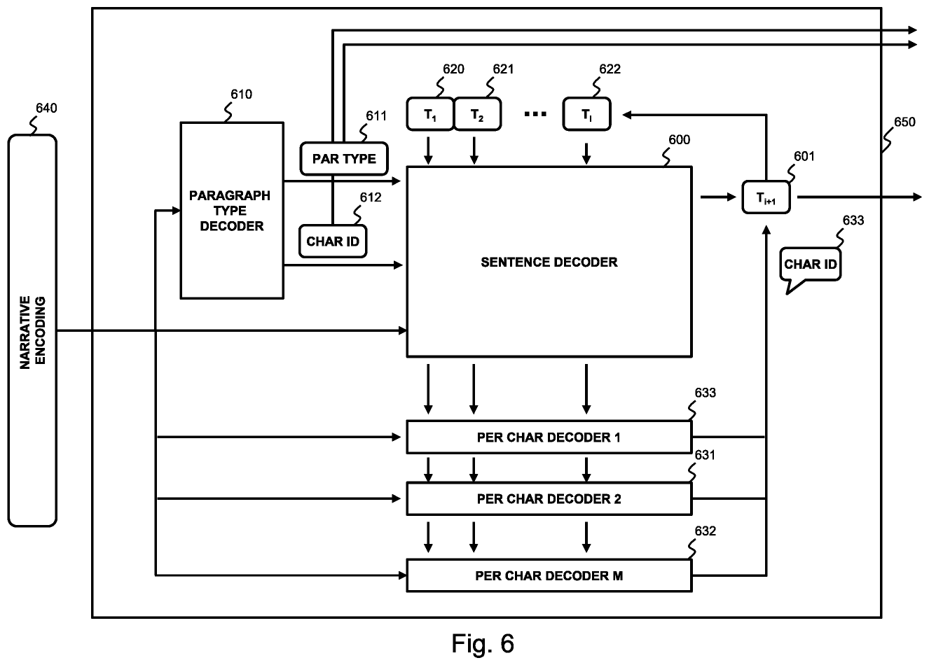

FIG. 6 illustrates an example embodiment 650 of the next sentence decoder 350 within the machine learning model 300. The decoder 350 further comprises several decoders 610, 600, 631-633 which are each trainable to perform predictions of the constituents of a next annotated sentence. When a previous annotated sentence has been generated and when the narrative encoding 640 has been updated, a first paragraph type decoder predicts from the narrative encoding 640 the paragraph type 611 and, if applicable, the identification of the speaking character 612. The paragraph type 611 and character identification 612 is then provided together with the narrative encoding 640 to a second decoder, the sentence decoder 600. This decoder 600 is trained to infer a next token 601 of the current sentence based on this input and based on the previously predicted tokens 620-622 of the current sentence. Decoder 600 iteratively predicts such a next token 601 until it generates an end of sentence token. Decoder 650 further comprises respective per-character decoders 631-633 trained for generating a character identification 633 associated with generated reference tokens.

The next sentence decoder 350 may further comprise a so-called ‘discriminator’ component at the output of the sentence decoder 600 (not show in FIG. 6). This component is a separately trained neural network having a similar encoding structure as the machine learning model 300. The difference is that the decoding part of this component only has one probability as output instead of a complete sentence. This probability is indicative for the acceptance of the generated sentence. When the generated probability is below a certain threshold, then the generated sentence is rejected and the sentence decoder 600 is instructed to generate a new prediction for the next sentence. When the generated probability is not below a certain threshold, then the generated sentence is accepted and the machine learning model 300 proceeds to the generation of the next sentence.

In the context of a machine learning module, a prediction comprises the assigning of probabilities to all possible outcomes, i.e. all possible paragraph types, tokens and character identifications. These probabilities are then subsequently used to draw a sample resulting in the actual predictions 611, 612, 601 and 633.

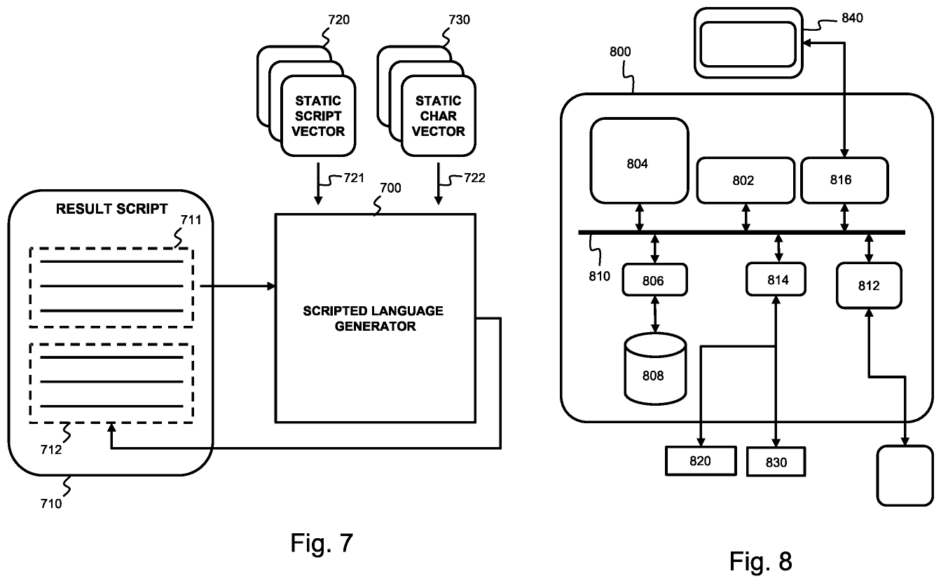

FIG. 7 illustrates an example embodiment for generating a narrative script 710 by a scripted language generator 700. The generator 700 comprises the machine learning model 300. This model 300 may be trained to generate scripted narratives using a large training set of existing scripted narratives. The generator 700 may further comprise means for converting sentences of a scripted narrative into an annotated sentence representation 100 and vice versa. Interaction with the generator 700 may also be performed directly by use of the proposed format of the annotated sentences.

Generator 700 may take one or more sentences 711 as input and thereupon iteratively generate the remaining sentences 712 of a scripted narrative, i.e. take a partial script as input. In such a case the static script vector and static character vectors may be derived from this partial script and used as biasing input for the narrative encoder 500. Furthermore, generator 700 may take one or more static vectors 720, 730 as input, or any of the other before mentioned static vectors such as the positional encoding or the biasing synopsis encoding. The generated sentences will then be biased according to the input static script vectors 721 and input static character vectors 722.

Further interaction with a user may be provided by allowing a user to: i) add new text in any of the possible paragraph types 101, ii) to specify speaking characters 111 and referred characters 125, iii) to alter character references, iv) to specify a biasing synopsis from which the biasing synopsis encoding is derived. In other words, the generator 700 with machine learning model 300 can be configured to automatically generate further annotated sentences starting from any point within an already present or generated text. The generator 700 will then take into account all preceding text and character references of the scripted narrative, even when manual changes have been made.

FIG. 8 shows a suitable computing system 800 enabling to implement the different aspects of generator 700 and machine learning model 300. Computing system 800 may in general be formed as a suitable general-purpose computer and comprise a bus 810, a processor 802, a local memory 804, one or more optional input interfaces 814, one or more optional output interfaces 816, a communication interface 812, a storage element interface 806, and one or more storage elements 808. Bus 810 may comprise one or more conductors that permit communication among the components of the computing system 800. Processor 802 may include any type of conventional processor or microprocessor that interprets and executes programming instructions. Local memory 804 may include a random-access memory (RAM) or another type of dynamic storage device that stores information and instructions for execution by processor 802 and/or a read only memory (ROM) or another type of static storage device that stores static information and instructions for use by processor 802. Input interface 814 may comprise one or more conventional mechanisms that permit an operator or user to input information to the computing device 800, such as a keyboard 820, a mouse 830, a pen, voice recognition and/or biometric mechanisms, a camera, etc. Output interface 816 may comprise one or more conventional mechanisms that output information to the operator or user, such as a display 840, etc. Communication interface 812 may comprise any transceiver-like mechanism such as for example one or more Ethernet interfaces that enables computing system 800 to communicate with other devices and/or systems. The communication interface 812 of computing system 800 may be connected to such another computing system by means of a local area network (LAN) or a wide area network (WAN) such as for example the internet. Storage element interface 806 may comprise a storage interface such as for example a Serial Advanced Technology Attachment (SATA) interface or a Small Computer System Interface (SCSI) for connecting bus 810 to one or more storage elements 808, such as one or more local disks, for example SATA disk drives, and control the reading and writing of data to and/or from these storage elements 808. Although the storage element(s) 808 above is/are described as a local disk, in general any other suitable computer-readable media such as a removable magnetic disk, optical storage media such as a CD or DVD, -ROM disk, solid state drives, flash memory cards, . . . could be used.

As used in this application, the term “circuitry” may refer to one or more or all of the following:

(a) hardware-only circuit implementations such as implementations in only analog and/or digital circuitry and

(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions) and

(c) hardware circuit(s) and/or processor(s), such as microprocessor(s) or a portion of a microprocessor(s), that requires software (e.g. firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in a server, a cellular network device, or other computing or network device.

Although the present invention has been illustrated by reference to specific embodiments, it will be apparent to those skilled in the art that the invention is not limited to the details of the foregoing illustrative embodiments, and that the present invention may be embodied with various changes and modifications without departing from the scope thereof. The present embodiments are therefore to be considered in all respects as illustrative and not restrictive, the scope of the invention being indicated by the appended claims rather than by the foregoing description, and all changes which come within the scope of the claims are therefore intended to be embraced therein.

It will furthermore be understood by the reader of this patent application that the words “comprising” or “comprise” do not exclude other elements or steps, that the words “a” or “an” do not exclude a plurality, and that a single element, such as a computer system, a processor, or another integrated unit may fulfil the functions of several means recited in the claims. Any reference signs in the claims shall not be construed as limiting the respective claims concerned. The terms “first”, “second”, third”, “a”, “b”, “c”, and the like, when used in the description or in the claims are introduced to distinguish between similar elements or steps and are not necessarily describing a sequential or chronological order. Similarly, the terms “top”, “bottom”, “over”, “under”, and the like are introduced for descriptive purposes and not necessarily to denote relative positions. It is to be understood that the terms so used are interchangeable under appropriate circumstances and embodiments of the invention are capable of operating according to the present invention in other sequences, or in orientations different from the one(s) described or illustrated above.

1. A computer-implemented method for generating a scripted narrative by a machine learning model comprising:
predicting the scripted narrative as a sequence of annotated sentences;
and wherein an annotated sentence comprises one or more tokens and a paragraph type; and wherein a token is selectable from a token group comprising at least a word token indicative for a word in the scripted narrative and a reference token indicative for a term that refers to a character; and wherein, when a token is a reference token, it is further annotated with an identification of the referred character;
and wherein the predicting further comprises:
iteratively predicting a next annotated sentence based on a sequence of preceding annotated sentences;
and wherein the predicting the next annotated sentence comprises:
predicting the paragraph type of the next annotated sentence;
iteratively predicting a next token based on the sequence of preceding annotated sentences and from previously predicted tokens.

2. The method according to claim 1 further comprising:
encoding, by a sentence sequence model, the paragraph type and tokens of annotated sentences into respective per-sentence encodings;
encoding, by the sentence sequence model, character information of the annotated sentences into respective per-character-per-sentence encodings.

3. The method according to claim 2 further comprising:
encoding, by a narrative encoder, from the per-sentence encodings and from the per-character encodings, a single narrative encoding.

4. The method according to claim 3 wherein the encoding the single narrative encoding further comprises:
encoding, by a global encoder model, the per-sentence encodings into a first portion of the single narrative encoding; and
encoding, by global per-character encoder models, the per-character-per-sentence encodings into a second portion of the single narrative encoding.

5. The method according to claim 4 wherein the encoding, by the global encoder model, is further performed according to a static biasing narrative encoding.

6. The method according to claim 4 wherein the encoding, by the global per-character encoder models is further performed according to respective static biasing character encodings.

7. The method according to claim 1, further comprising the step of:
training the machine learning model by a set of scripted narratives.

8. The method according to claim 1, further comprising the step of:
providing a first set of sentences as input to the machine learning model;
generating a subsequent set of sentences by the machine learning model.

9. The method according to claim 5, further comprising the steps of:
determining the static biasing narrative encoding from a bias scripted narrative; and
providing the static biasing narrative encoding to the machine learning model.

10. The method according to claim 6, further comprising the steps of:
determining, a first per-character-per-sentence encoding from a bias scripted narrative; and
providing the first per-character-per-sentence encoding as a static biasing character encoding to the machine learning model.

11. The method according to claim 1 wherein an annotated sentence further comprises a sentence character identification identifying the character speaking the sentence.

12. A machine learning model comprising a decoder configured to:
predict a scripted narrative as a sequence of annotated sentences;
and wherein an annotated sentence comprises one or more tokens and a paragraph type;
and wherein a token is selectable from a token group comprising at least a word token indicative for a word in the scripted narrative and a reference token indicative for a term that refers to a character; and
wherein, when a token is a reference token, it is further annotated with an identification of the referred character;
and wherein the predicting further comprises:
iteratively predicting a next annotated sentence based on a sequence of preceding annotated sentences;
and wherein the predicting the next annotated sentence comprises:
predicting the paragraph type of the next annotated sentence;
iteratively predicting a next token based on the sequence of preceding annotated sentences and from previously predicted tokens.

13. A controller comprising at least one processor and at least one memory including computer program code, the at least one memory and computer program code configured to, with the at least one processor, cause the controller to perform the method of claim 1.

14. A computer program product comprising computer-executable instructions for performing the steps according to claim 1 when the program is run on a computer.

15. A computer readable storage medium comprising computer-executable instructions for performing the steps according to claim 1 when the program is run on a computer.
